(19) United States
(12) Patent Application Publication
(10) Pub. No.: US 2009/0205234 A1
(43) Pub. Date: Aug. 20, 2009

(54) THERMOCOLOR WRISTBAND AND LABELS

(75) Inventor: Edward D. Hammerslag, Thousand Oaks, CA (US)

Correspondence Address: KELLY LOWRY & KELLEY, LLP, 6320 CANOGA AVENUE, SUITE 1650, WOODLAND HILLS, CA, 91367, US

(73) Assignee: PRECISION DYNAMICS CORPORATION, San Fernando, CA (US)

(21) Appl. No.: 12/388,364

(22) Filed: Feb. 18, 2009

Related U.S. Application Data
(60) Provisional application No. 61/029,983, filed on Feb. 20, 2008.

(51) Int. Cl. A44C 5/00; B44F 1/10; G09F 3/00

(52) U.S. Cl. 40/633; 428/29; 40/299.01

(57) ABSTRACT

A thermally activated, multi-color identification device having a substrate, an adhesive layer and a thermal activation layer underlying a protective coating. The thermal activation layer includes multiple regions of multi-colored thermal sensitive coating to achieve multi-color thermal printing on a single media. Alternatively, the thermal activation layer may be mono-color with regions of multi-colored ink underlying the thermal activation layer. The protective coating may be a polymer or varnish to protect the thermal activation layer from environmental hazards. The clear protective coating permits uniform activation of the thermal activation layer while protecting the same.

### BACKGROUND OF THE INVENTION

This invention relates generally to identification devices, namely, wristbands and labels. More specifically, this invention relates to wristbands and/or labels having a thermal sensitive coating.

Current products having thermal coatings place the thermal coating as a top layer of several layers so that the thermal coating is easily activated with thermal printheads. Some prior art devices provide a protective layer including a coating or varnish to seal the thermal layer from damage by solvents or other materials. Such coatings or varnishes are problematic due to manufacturing inconsistencies such as coating thicknesses, chemical reactions with liquids that the final product may come into contact with and inconsistencies in the chemical makeup of the coating. Such issues are of greater concern to users of the product in harsh environments such as healthcare facilities. In these types of facilities the identification device may be exposed to alcohol, creams and/or gels that are harmful to the thermal layer. Other harsh environments include water parks where chemicals like chlorine are present.

In healthcare, leisure and entertainment arenas there is a need for a multi-color thermal identification product. Current thermal identification products on the market print mono-colors rather than multi-colors. In order to change color, a provider would need to change identification product. A multi-color, thermally printed identification device may be used to identify patients, products or patrons with different attributes. Other products on the market have provided multi-color thermal bands where each color is activated by a different thermal energy thus requiring an expensive thermal printer to provide variations in thermal energy.

Recently, many states are instituting requirements for healthcare providers to adopt common colors on wristbands to indicate specific patient requests or requirements, i.e., DNR (do not resuscitate), allergies, fall risk, etc. In patron management, different color wristbands may be used to indicate different entitlements such as legal drinking age for alcohol consumption or entitlement to enter certain restricted areas. A ski lodge may use different colored wristbands to indicate morning, afternoon or night skiing privileges. Colored labels can also indicate the attributes of different products like size, age or compatibility with other products.

Accordingly, there is a need for an identification device that would allow a user to thermally print multiple colors on the same wristband or label without changing media. In addition, there is a need for a product that would allow a user to print different colors on separate wristbands or labels using a thermal printer without changing configuration or setup. Further, there is a need for the ability to print wristbands or labels in multi-colors using a thermal printer whereby the printed material is protected from environmental hazards such as alcohol, hand sanitizers, moisture, etc. The present invention fulfills these needs and provides other related advantages.

### SUMMARY OF THE INVENTION

The present invention is directed to identification devices, preferably wristbands, labels or cards. The identification devices have a construction which permits the use of a thermal printer to print different colors on the same media. The present invention also provides protection to the thermally printed media from environmental hazards.

The present invention is directed to a thermally activated identification device for presenting a plurality of colors upon thermal activation. The identification device comprises a flexible base substrate, a thermal activation layer disposed adjacent to the substrate, and a clear, protective layer applied to the substrate such that the thermal activation layer is enclosed therebetween. The thermal activation layer comprises a plurality of discrete regions, each associated with a color. The protective layer comprises either a clear polymer or a clear varnish.

The substrate preferably comprises a mono-, bi- or tri-laminate material that is durable and capable of being printed upon. The substrate may have colored areas or printed material under the polymer layer. In this embodiment, the thermal activation layer comprises a clear thermal coating that can selectively turn black, in all or part, upon activation.

In another embodiment, each of the plurality of discrete regions in the thermal activation layer may be comprised of a thermally activated ink, wherein the thermally activated ink in a particular region corresponds to the color associated with that region. In this embodiment, the thermal activation layer comprises an under layer and an upper layer. The under layer is divided into the plurality of discrete regions, each region corresponding to a different color. The upper layer comprises a clear thermal coating that can selectively turn black, in all or part, upon activation.

The plurality of colors may comprise blue, red, green and black. The thermally activated identification device may further comprise an adhesive layer between the substrate and the thermal activation layer. Alternatively, the thermal activation layer may be mixed with an adhesive.

The polymer layer preferably comprises polyester or polyethylene terephthalate. The thermal activation layer may be adhered to an underside of the polymer layer before it is laminated to the substrate. This would assure that the thermal activation layer is a uniform distance from the top surface of the polymer layer.

The identification device preferably comprises a wristband, a label or a card. The thermally activated identification device may be a medical identification device and each of the colors of each discrete region corresponds to a specific patient request or requirement. The thermally activated identification device may be a patron identification device and each of the colors of each discrete region corresponds to a specific patron entitlement.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a cross-sectional view of an identification device embodying the present invention;

FIG. 2 is a cross-sectional view of an alternate embodiment of the present invention;

FIG. 3 is a top view of a wristband embodying the device shown in FIG. 1 with printed words in each of the colored regions;

FIG. 4 is a top view of a wristband embodying the device shown in FIG. 1 with printed bars in each of the colored regions;

FIG. 5 is a top view of a wristband embodying the device shown in FIG. 1 with printed circles in each of the colored regions;

FIG. 6 is a top view of a sheet of labels embodying the present invention; and

FIG. 7 is a cross-sectional view of an identification device embodying an alternative embodiment of the present invention.

### DETAILED DESCRIPTION OF THE PREFERRED EMBODIMENTS

The present invention is concerned with thermally activated, multi-color identification devices having a protective coating. More specifically, the present invention is directed to laminated identification wristbands, labels or cards that are capable of being thermally printed in multiple colors and are protected from damage by environmental hazards. The identification devices have a construction which permits the use of a thermal printer to print multiple colors on the same media.

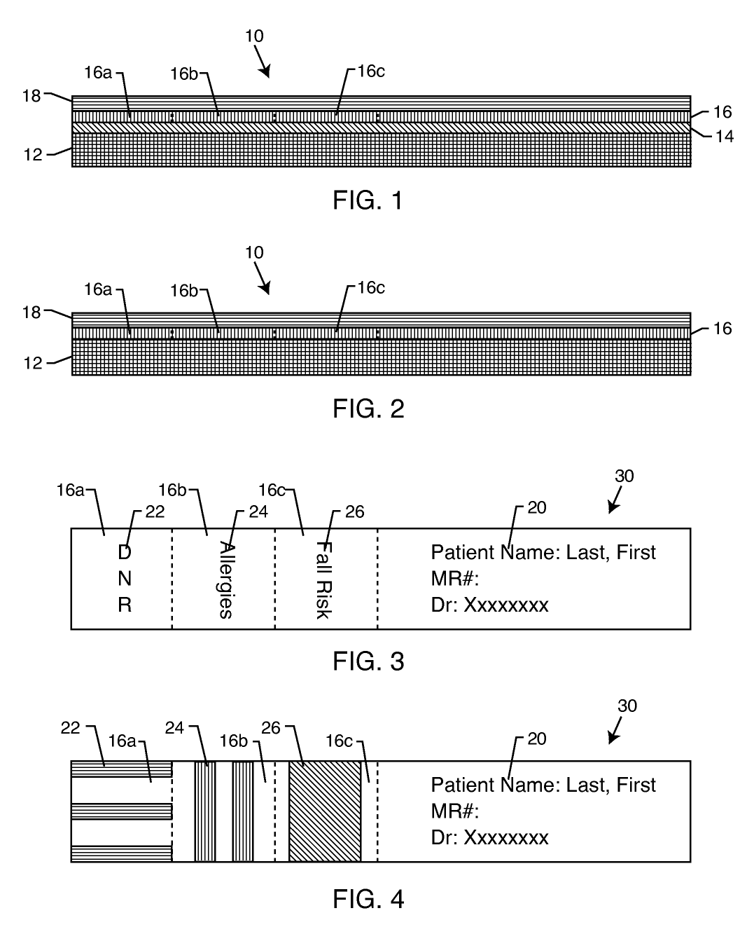

FIG. 1 depicts a cross-sectional view of an identification device 10 of the present invention. This embodiment shows four layers laminated together—a substrate or liner layer 12, an adhesive layer 14, a thermal activation layer 16, and a clear protective layer 18. As described further below, the adhesive layer 14 may be omitted or blended with the thermal activation layer 16. The thermal activation layer preferably includes two or more discrete regions (16a, 16b, 16c), with each region associated with different colors of thermally activated material, as described more fully below.

The substrate or liner layer 12 is made from any flexible, durable material, i.e., film or polymer, commonly used in wristbands or similar identification devices. Preferably, the liner layer 12 is comprised of a mono-, bi- or tri-laminate film. The material that comprises the liner layer 12 may be impregnated with colored ink or may receive printed matter on an exposed surface as needed without altering the performance of this invention.

The adhesive layer 14 adheres the liner layer 12 to the thermal activation layer 16. Such adhesive layer 14 may be a pressure sensitive, ultraviolet, or other commonly used adhesive. The selected adhesive must be one that will not be damaged by the heat from the thermal printer.

As discussed above, the separate adhesive layer 14 may be omitted from the identification device as depicted in FIG. 2. In this embodiment, the identification device would comprise the substrate or liner layer 12, color thermal sensitive coatings 16 of various colors are applied thereto, and a clear protective layer 18. The reason for eliminating the adhesive layer 14 would be to avoid a manufacturing step. If the adhesive layer 14 is omitted, then the application of the clear protective layer 18 to the liner layer 12 should be of sufficient strength and durability to maintain the thermal activation layer 16 therebetween.

Alternatively, the thermal material 16 may be placed on the underside of the clear protective layer 18 prior to application. In such case, the thermal layer 16 will be activated through the clear protective layer 18 and imaged on the underside to insure a consistent activation. This clear protective layer 18 could also be treated with UV inhibitors or anti-oxidants to protect the thermal layers 16 from exposure to harmful UV rays or oxidation. The exposure to UV light and oxygen reduces the print quality and causes the print to “fade” prematurely. This is a critical problem with direct thermal printed cards, labels and wristbands

Alternatively, the thermal activation layer 16 may be combined with an adhesive prior to application to the liner layer 12. In this manner, the activation layer 16 self-adheres to the liner layer 12 without the need for a separate adhesive layer 14.

The thermal activation layer 16 along with its multiple discrete regions 16a, 16b, 16c can be any thermal sensitive coating used with thermal printers. The thermal activation layer 16 needs to be capable of activation by a thermal printer print head to receive printed information 20, 22, 24, 26. When any of these various regions are activated by a thermal printer the associated color appears in the activated region.

Once activated, the effect of the thermal activation layer 16 may vary. In the most basic embodiment, the thermal activation layer 16 may print letters, numbers and other characters according to the signals sent to the thermal printer. Alternatively, the thermal activation layer 16 may be designed to print different colors or shapes according to the signals sent to the thermal printer and the region activated.

In a preferred embodiment, the regions may allow for a blue thermal coating, a red thermal coating, a green thermal coating and a black thermal coating. Specifically, the thermal activation layer 16 associated with the printed information 20 would be black, the thermal activation layer 16a associated with the printed information 22 would be blue, the thermal activation layer 16b associated with the printed information 24 would be red, and the thermal activation layer 16c associated the printed information 26 would be green. Thus, any words, characters, numbers or shapes printed in any of regions 16, 16a, 16b, and 16c would have the color of the underlying thermal sensitive coating.

The clear protective layer 18 may be a polymer or plastic laminated to the substrate 12 over the color thermal sensitive coatings 16. Such a clear plastic layer 18 is preferably polyester, polyethylene terephthalate (PET) or other strong, thin protective film. The clear plastic layer 18 of the present invention creates a uniform thickness, assuring that the thermal activation layer 16 is a known fixed distance from the print head over its entire length. This uniformity of thickness in the clear plastic layer 18 results in more consistent activation of the thermal activation layer 16 along its length. The clear plastic layer 18 is resistant to the chemical and solvents found in harsh environments such as alcohol, other solvents, hand sanitizers and moisture. In a preferred embodiment, the clear plastic layer 18 is PET between 0.5 millimeters and 1.0 millimeters thick. This thickness of PET provides sufficient protection of the thermal activation layer 16 against environmental hazards while producing consistent print results. The clear protective layer 18 may also be a conventional clear varnish applied over the thermal activation layer 16.

The laminated identification device 10 can be run through a standard thermal printer and depending upon which region or regions of color thermal sensitive coatings 16 are activated by the thermal printhead, various colors may appear through the clear plastic layer 18. The resulting thermal color image will be trapped between the clear plastic layer 18 and the substrate 12.

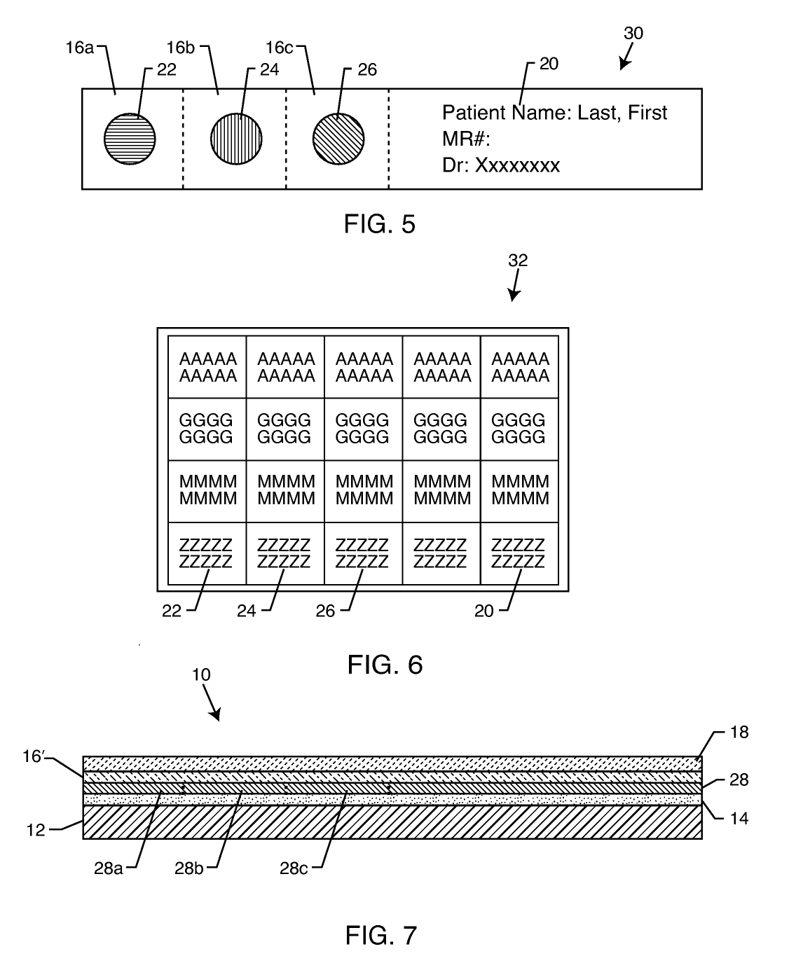

FIGS. 3, 4 and 5 depict top views of a wristband 30 and FIG. 6 depicts a top view of a sheet of labels/cards 32, each embodying the present invention. Regardless of whether the identification device embodies a wristband 30 or labels/cards 32, the inclusion of a multi-colored thermal activation layer 16 underlying a clear plastic layer 18 can be embodied therein to achieve the desired results.

As illustrated in FIG. 7, in an alternate embodiment, the thermal activation layer 16 and regions 16a, 16b, 16c may be replaced with a layer of various regions of colored ink 28, 28a, 28b, 28c underlying a layer of black thermal activation layer 16′. As above, the regions of colored ink 20, 28a, 28b, 28c would be presented in various colors, i.e., black, blue, red and green. In this embodiment, the regions of colored ink 28, 28a, 28b, 28c would show through initially and a thermal printer would activate the black thermal activation layer 16′ to black-out the underlying color where it was not desired to show through. In this alternate embodiment, a thermal printer would print a negative of the desired image.

In another alternate embodiment, again referring to FIG. 7, the layer of various regions of colored ink 28, 28a, 28b, 28c may be adhered to the substrate 12 as depicted or printed directly on the substrate 12. A black thermal activation layer 16′ may then be placed on top of the regions of colored ink 28, 28a, 28b, 28c as described above. This embodiment, rather than having clear plastic layer 18 may instead have a conventional varnish coating 18 to cover the black thermal activation layer 16′. Again, this embodiment would require a thermal printer to print a negative of the desired image.

Although several embodiments have been described in detail for purposes of illustration, various modifications may be made without departing from the scope and spirit of the invention. Accordingly, the invention is not to be limited, except as by the appended claims.

What is claimed is:

1. A thermally activated identification device for presenting a plurality of colors upon thermal activation, comprising:
a flexible base substrate;
a thermal activation layer disposed adjacent to the substrate, comprising a plurality of discrete regions, each associated with a color; and
a clear, protective layer applied to the substrate such that the thermal activation layer is enclosed therebetween.

2. The thermally activated identification device of claim 1, wherein the clear, protective layer is either a clear varnish applied to the substrate or a clear polymer layer laminated to the substrate.

3. The thermally activated identification device of claim 2, wherein the polymer layer comprises polyester or polyethylene terephthalate.

4. The thermally activated identification device of claim 1, wherein the substrate comprises a mono-, bi- or tri-laminate material.

5. The thermally activated identification device of claim 1, wherein the substrate has colored areas or printed material under the protective layer.

6. The thermally activated identification device of claim 5, wherein the thermal activation layer comprises a clear thermal coating that selectively turns black, in all or part, upon activation.

7. The thermally activated identification device of claim 1, wherein each of the plurality of discrete regions in the thermal activation layer are comprised of a thermally activated ink, wherein the thermally activated ink in a particular region corresponds to the color associated with the region.

8. The thermally activated identification device of claim 7, wherein the thermal activation layer comprises an under layer divided into the plurality of discrete regions and an upper layer comprising a clear thermal coating that selectively turns black, in all or part, upon activation.

9. The thermally activated identification device of claim 1, wherein the plurality of discrete regions are associated with the colors blue, red, green and black.

10. The thermally activated identification device of claim 1, further comprising an adhesive layer between the substrate and the thermal activation layer.

11. The thermally activated identification device of claim 1, wherein the thermal activation layer is mixed with an adhesive.

12. The thermally activated identification device of claim 1, wherein the thermal activation layer is adhered to an underside of the protective layer before it is applied to the substrate.

13. The thermally activated identification device of claim 1, wherein the identification device comprises a wristband, a label or a card.

14. The thermally activated identification device of claim 1, wherein the thermally activated identification device is a medical identification device and each of the discrete regions have a color corresponding to a specific patient request or requirement.

15. The thermally activated identification device of claim 1, wherein the thermally activated identification device is a patron identification device and each of the discrete regions have a color corresponding to a specific patron entitlement.

16. A thermally activated identification device for presenting a plurality of colors upon thermal activation, comprising:
a flexible base substrate having colored areas or printed material;
a thermal activation layer comprising a clear thermal coating that selectively turns black, in all or part, upon activation, the thermal activation layer disposed adjacent to the substrate and comprising a plurality of discrete regions, each associated with the colored areas or printed material on the substrate; and
a clear, polymer layer laminated to the substrate such that the thermal activation layer is enclosed therebetween.

17. The thermally activated identification device of claim 16, wherein the substrate comprises a mono-, bi- or tri-laminate material.

18. The thermally activated identification device of claim 16, wherein the plurality of discrete regions are associated with the colors blue, red, green and black.

19. The thermally activated identification device of claim 16, further comprising an adhesive layer between the substrate and the thermal activation layer.

20. The thermally activated identification device of claim 16, wherein the thermal activation layer is mixed with an adhesive.

21. The thermally activated identification device of claim 16, wherein the polymer layer comprises polyester or polyethylene terephthalate.

22. The thermally activated identification device of claim 16, wherein the thermal activation layer is adhered to an underside of the polymer layer before it is laminated to the substrate.

23. The thermally activated identification device of claim 16, wherein the identification device comprises a wristband, a label or a card.

24. The thermally activated identification device of claim 16, wherein the thermally activated identification device is a medical identification device and each of the discrete regions have a color corresponding to a specific patient request or requirement.

25. The thermally activated identification device of claim 16, wherein the thermally activated identification device is a patron identification device and each of the discrete regions have a color corresponding to a specific patron entitlement.

26. A thermally activated identification device for presenting a plurality of colors upon thermal activation, comprising:
a flexible base substrate;
a thermal activation layer disposed adjacent to the substrate, the thermal activation layer having an under layer divided into a plurality of discrete regions, each region comprised of a thermally activated ink corresponding to a color, and an upper layer comprising a clear thermal coating that selectively turns black, in all or part, upon activation; and
a clear, polymer layer laminated to the substrate such that the thermal activation layer is enclosed therebetween.

27. The thermally activated identification device of claim 26, wherein the substrate comprises a mono-, bi- or tri-laminate material.

28. The thermally activated identification device of claim 26, wherein the plurality of discrete regions are associated with the colors blue, red, green and black.

29. The thermally activated identification device of claim 26, further comprising an adhesive layer between the substrate and the thermal activation layer.

30. The thermally activated identification device of claim 26, wherein the thermal activation layer is mixed with an adhesive.

31. The thermally activated identification device of claim 26, wherein the polymer layer comprises polyester or polyethylene terephthalate.

32. The thermally activated identification device of claim 26, wherein the thermal activation layer is adhered to an underside of the polymer layer before it is laminated to the substrate.

33. The thermally activated identification device of claim 26, wherein the identification device comprises a wristband, a label or a card.

34. The thermally activated identification device of claim 26, wherein the thermally activated identification device is a medical identification device and each of the discrete regions have a color corresponding to a specific patient request or requirement.

35. The thermally activated identification device of claim 26, wherein the thermally activated identification device is a patron identification device and each of the discrete regions have a color corresponding to a specific patron entitlement.
